(19) United States
(12) Patent Application Publication
(10) Pub. No.: US 2026/0235176 A1
(43) Pub. Date: Aug. 13, 2026

(54) ROTOR HUB AND METHODS THEREOF

(71) Applicant: Cole Danell, Visalia, CA (US)

(72) Inventor: Cole Danell, Visalia, CA (US)

(21) Appl. No.: 19/051,903

(22) Filed: Feb. 12, 2025

(51) Int. Cl. F16D 65/12; F16D 65/02

(52) U.S. Cl. CPC F16D 65/128; F16D 65/123; F16D 2065/1332

(57) ABSTRACT

An inboard rotor hub adapter and assembly, configured for use in high-performance vehicle braking systems, is disclosed. The hub adapter includes a central hub for mounting onto an axle shaft and a plurality of radially distributed vanes each having a blade body, a reinforcing member with a through-hole for fastening a brake disc, and a fluid channel positioned therebetween. The vane geometry being operable to generate a radial airflow and create a pressure gradient during rotation, thereby directing cooling air toward and across the brake disc.

### FIELD OF THE INVENTION

The present invention relates generally to a rotor hub operable to cool a brake disc. More particularly, the present invention provides a rotor hub with a plurality of vanes each being operable to generate a flow of air to cool a braking assembly.

### BACKGROUND OF THE INVENTION

The present invention relates to advancements in floating brake discs, with a specific focus on the inboard rotor hub. Floating brake discs are critical components in vehicles, including motorcycles and high-performance racing vehicles like sprint cars. These systems are designed to manage the intense thermal and mechanical stresses associated with braking under demanding conditions. A floating brake disc typically consists of an outer ring that supports the brake band and an inboard rotor hub that connects the brake disc to the wheel or axle assembly. This design allows controlled movement between components, helping to mitigate thermal expansion and distribute braking forces effectively.

In sprint cars, a specialized configuration known as an inboard brake system is commonly employed. These systems position the brake assembly near the vehicle's centerline, typically on the rear axle. This centralized arrangement offers several advantages, such as reduced unsprung weight for improved suspension responsiveness and enhanced handling. Additionally, the central placement protects the brake assembly from dirt, debris, and impact damage, making inboard systems particularly suited to the harsh environments encountered in sprint car racing.

To meet the demands of high-performance racing, inboard brake systems often incorporate floating brake discs, which are specifically designed to handle the intense braking forces and stresses experienced during operation. By allowing limited relative movement between the outer ring and the inboard rotor hub, floating discs effectively absorb thermal expansion and mechanical strain. However, inboard systems also face significant challenges that impact their performance and reliability, particularly in heat transfer and cooling.

Inboard brake systems struggle with effectively dissipating the heat generated during intense braking. Unlike outboard systems, which are mounted directly at the wheels and benefit from airflow for natural cooling, inboard brakes are located near the vehicle's centerline, where airflow is significantly reduced. This restricted airflow limits the system's ability to transfer heat away from the rotor, causing elevated operating temperatures. Additionally, the confined location of inboard systems compounds cooling challenges. Brake components are surrounded by drivetrain elements, which restrict airflow and create a heat-concentrated environment. This results in heat soak, reducing braking performance and accelerating wear on critical parts.

High and sustained temperatures also increase thermal expansion in brake components, placing additional stress on the connectors between the inboard rotor hub and the outer ring. Over time, this thermal cycling degrades the integrity of the connectors, leading to frequent maintenance or replacement. Furthermore, the combination of high temperatures and intense mechanical stresses accelerates material fatigue, particularly in the brake disc and inboard rotor hub, reducing the overall durability of the system and increasing the risk of component failure during operation.

This invention seeks to address these shortcomings with an improved floating brake disc featuring a novel inboard rotor hub design. By optimizing heat distribution and improving cooling efficiency through advanced materials and structural innovations, the invention reduces stress on connectors and other critical components. The result is a more durable, reliable braking system capable of meeting the extreme performance demands of sprint car racing, ensuring consistent operation even under the most challenging conditions.

### SUMMARY OF THE INVENTION

The present invention relates to an inboard floating rotor assembly for improving cooling efficiency, structural integrity, and system compatibility in braking applications. The rotor assembly may include a floating hub adapter that securely mounts a brake disc onto an axle shaft. The hub adapter may incorporate a central hub with a central bore. In some embodiments, the central bore may include a plurality of splines to facilitate alignment and secure attachment to the axle shaft. Extending radially outward from the central hub are a plurality of vanes. These vanes are arranged to form an impeller, which is operable to generate radial airflow, thereby cooling the brake disc and other associated components during operation.

In some embodiments, the plurality of vanes may include a primary vane and a secondary vane (e.g., reinforcing member), which are spatially separated by a fluid channel. The primary vane features a curved surface extending along the length of the central hub to maximize airflow interaction and enhance cooling performance. The secondary vane functions as a structural reinforcement, providing mechanical support to the brake disc while minimizing obstruction to airflow. Together, the primary and secondary vanes cooperate to establish a centrifugal airflow pattern, producing a pressure gradient that facilitates consistent airflow through the rotor. This airflow promotes uniform cooling across the brake disc's surface, mitigating localized thermal stress.

To accommodate various operational requirements, the rotor assembly may include multiple vane geometries, such as forward-curved, flat, or backward-curved configurations, which adjust the airflow direction and performance characteristics. The hub adapter may also include a standardized bolt pattern with through-holes, facilitating the secure attachment of the brake disc while maintaining compatibility across different braking systems. In certain embodiments, additional alignment features, such as pins or slots, are integrated to ensure proper orientation of vented or slotted brake discs. These features optimize airflow and further enhance cooling efficiency. In some embodiments, to ensure precise alignment of the brake disc relative to the rotor hub adapter and achieve consistent orientation during assembly, the hub adapter may incorporate a series of indexing features, such as integral pins, slots, or shaped recesses, positioned at predetermined intervals adjacent to the through-holes. These features may be formed as raised bosses, tapered guide holes, or complementary contours designed to engage corresponding apertures or mating surfaces on the brake disc. By controlling tolerances and angular placement, these indexing features guide the brake disc into a fixed orientation, preventing rotation or lateral shifting during operation. As a result, the disc's vented or slotted patterns may be consistently positioned to optimize airflow and cooling efficiency, ensuring reproducible performance and facilitating quicker, more reliable installation in the field.

The vanes and fluid channels have a geometry that is optimized to direct air movement along the radial path of the vanes, enhancing dynamic cooling through pulsating airflow patterns and reducing the presence of stagnant hot air. In some embodiments, the vanes may be constructed from thermally conductive materials to enable heat dissipation via convection, which further supports the cooling performance of the assembly. The fluid channels formed between the blade bodies and their reinforcing members may be configured to induce pulsating airflow patterns during rotation. As the rotor hub adapter spins, variations in channel cross-sectional area and blade spacing cause transient pressure fluctuations, generating small-scale vortices at the channel outlets. These vortices intermittently mix cooler ambient air with heated boundary layers adjacent to the brake disc surface. Over multiple rotations, this pulsating flow breaks up pockets of stagnant hot air, promoting uniform temperature distribution and reducing localized thermal gradients. Thus, by tuning the channel geometry and vane spacing, the rotor hub adapter continuously refreshes the airflow around the brake disc, improving cooling efficiency and helping maintain stable braking performance.

In some embodiments, the manufacturing process for the inboard floating rotor adapter may include casting or CNC machining or a combination of the two manufacturing methods to achieve the required structural precision and cost efficiency. For example, Casting processes may be employed to form the initial shape of components, such as the central hub and vanes, allowing for complex geometries and optimized material distribution. CNC machining may then be applied to refine critical features, including the splines within the central bore, bolt patterns, and fluid channel surfaces, thereby ensuring precise tolerances and alignment essential for high-performance applications. The rotor assembly may be constructed from materials selected for their suitability in demanding conditions, including lightweight alloys such as 7075 aluminum, aluminum, titanium, and magnesium, which provide a high strength-to-weight ratio. Alternatively, stainless steel or carbon-steel alloys may be utilized to enhance heat resistance and mechanical durability. For extreme performance requirements, advanced materials such as composites or ceramic compounds with high thermal conductivity and minimal thermal expansion may be implemented.

During operation, the rotor assembly generates a vortex by interacting with the surrounding air. This interaction creates a low-pressure zone near the inlet and a high-pressure zone near the outlet of the vanes, ensuring effective air circulation. The performance of this vortex effect varies proportionally with the rotational speed of the hub, enabling optimized cooling under diverse operating conditions. The rotor hub may also be adaptable for integration into drivetrain assemblies, where the rotor hub may be positioned between a wheel and a differential, concentrically aligned with an axle shaft. Variations in vane geometry, bolt patterns, and material selection allow customization for specific applications.

It is an aspect of the present invention to provide a rotor hub adapter for an inboard braking system that is operable to secure to an axle shaft and may feature a plurality of vanes radially distributed around its circumference. Each vane may include a blade body extending radially outward from a root portion connected to the hub, a leading edge, a trailing edge, and a blade surface between the edges, with the blade surface having a primary and a secondary peripheral edge. Each vane may further include a reinforcing member connected to the root portion and the primary peripheral edge, with the reinforcing member having a through-hole positioned between the primary and secondary peripheral edges, and a fluid channel positioned between the blade and the reinforcing member. The adapter may secure a brake disc to each through-hole of the vanes and may generate a radial airflow creating a pressure gradient, directing the airflow toward the brake disc for cooling. The blade body of the adapter may have a forward-curved geometry that may be operable to direct a magnitude of an airflow vector toward the brake disc, while the fluid channel positioned between the blade and the reinforcing member may be operable to reduce turbulence and generate a pulsating flow during rotation, enhancing air mixing and mitigating heat stagnation around the brake disc. The reinforcing member may include a flat surface on the primary peripheral edge that may be operable to provide a uniform interface with the brake disc, with the through-hole positioned through the flat surface and operable to align with apertures on the brake disc for secure attachment. Indexing features may be included at the through-holes and may be operable to ensure proper alignment of the brake disc relative to the hub. The blade may form an air pressure gradient, having a low-pressure zone at the root of the blade and hub to draw in air and a high-pressure zone near the periphery to expel air at an increased velocity. The hub may secure to a shaft using splines on the interior surface of the hub that may align with splines on the axle shaft.

It is another aspect of the invention to provide a floating brake disc with a hub defining a central axis and a bore configured to mount the hub to an axle, wherein the hub may have a plurality of spokes radially extending to a periphery, with each spoke having a fan blade shape comprising a leading edge configured to guide airflow along the spoke and a trailing edge configured to discharge airflow radially outward. Contact surfaces at or near the periphery may be operable to align with corresponding apertures in a brake disc to secure it to the rotor hub, where the spokes may be operable to generate a centrifugal airflow pattern during rotation, directing airflow over and away from the brake disc to enhance heat dissipation and cooling of the braking assembly. Adjacent to each spoke may be a reinforcing member that may be operable to absorb braking loads transferred from the brake disc to the hub and provide structural support for the spoke under centrifugal forces. A fluid channel positioned between each spoke and its corresponding reinforcing member may be operable to reduce turbulence and generate a pulsating flow during rotation to enhance air mixing and mitigate heat stagnation. Contact surfaces may be strategically positioned along the periphery of each spoke to distribute the load of the brake disc evenly across the rotor hub, and the reinforcing member may include a flat surface at the peripheral edge that may be operable to provide a uniform interface with the brake disc. The blade may form an air pressure gradient having a low-pressure zone at the root to draw in air and a high-pressure zone near the periphery to expel air at increased velocity. The spokes and corresponding reinforcing members may be integrally formed as a single structure to enhance manufacturing simplicity and durability, and the bore of the hub may include splines that may align with splines on the axle for secure attachment and rotational synchronization.

It is another aspect of the present invention to provide method of cooling a braking assembly may include securing a rotor hub adapter to an axle shaft, wherein the adapter may comprise a hub defining a central axis and having a plurality of vanes radially distributed around the hub, and a brake disc fastened to through-holes at the peripheral edge of each vane, and the method may further include rotating the rotor hub adapter about its central axis, where each vane may generate a radial airflow by creating a pressure gradient, with the airflow being directed over the brake disc to dissipate heat generated during braking and away from the braking assembly to prevent heat stagnation. The airflow may be directed through a fluid channel positioned between each vane and a corresponding reinforcing member, where the channel may generate vortices at its outlet to enhance air mixing and prevent localized heat buildup around the brake disc. The brake disc may include slots or apertures that may guide the airflow generated by the vanes through the slots to enhance the cooling effect by increasing the surface area exposed to airflow. The method may further include maintaining balanced rotational dynamics of the rotor hub adapter by spacing the vanes equidistantly around the hub to minimize vibrations and noise during rotation and improve operational stability of the braking assembly.

Further aspects and embodiments will be apparent to those having skill in the art from the description and disclosure provided herein.

It is an object of the present invention to provide a rotor hub adapter and an associated inboard rotor assembly that efficiently cools a brake disc by generating and directing airflow, thereby reducing heat-related stresses, improving braking performance consistency, and enhancing the overall durability of the braking system.

The above-described objects, advantages, and features of the invention, together with the organization and manner of operation thereof, will become apparent from the following detailed description when taken in conjunction with the accompanying drawings, wherein like elements have like numerals throughout the several drawings described herein. Further benefits and other advantages of the present invention will become readily apparent from the detailed description of the preferred embodiments.

### BRIEF DESCRIPTION OF THE DRAWINGS

FIG. 1 provides an environmental perspective view of a floating rotor hub assembly secured to a rear end of a vehicle, according to an embodiment of the present invention.

FIG. 2 provides an isometric perspective view of a rotor hub adapter, according to an embodiment of the present invention.

FIG. 3 provides a front view of a rotor hub adapter, according to an embodiment of the present invention.

FIG. 4 provides a rear view of a rotor hub adapter, according to an embodiment of the present invention.

FIG. 5 provides a first side view of a rotor hub, according to an embodiment of the present invention.

FIG. 6 provides a second side view of a rotor hub, according to an embodiment of the present invention.

FIG. 7 provides a third side view of a rotor hub, according to an embodiment of the present invention.

FIG. 8 provides a fourth side view of a rotor hub, according to an embodiment of the present invention.

FIG. 9 provides a perspective front view of a rotor hub adapter, according to an embodiment of the present invention.

FIG. 10 provides a perspective rear view of a rotor hub adapter, according to an embodiment of the present invention.

FIG. 11 provides a front view of a rotor hub adapter securing a brake disc, according to an embodiment of the present invention.

FIG. 12 provides a side view of a floating rotor hub assembly secured to the rear end of a vehicle, according to an embodiment of the present invention.

FIG. 13 provides a side view of a floating rotor hub assembly secured to the rear end of a vehicle, according to an embodiment of the present invention.

### DETAILED DESCRIPTION

Reference will now be made in detail to certain embodiments of the invention, examples of which are illustrated in the accompanying drawings. While the invention will be described in reference to these embodiments, it will be understood that they are not intended to limit the invention. To the contrary, the invention is intended to cover alternatives, modifications, and equivalents that are included within the spirit and scope of the invention. In the following disclosure, specific details are given to provide a thorough understanding of the invention. However, it will be apparent to one skilled in the art that the present invention may be practiced without all of the specific details provided.

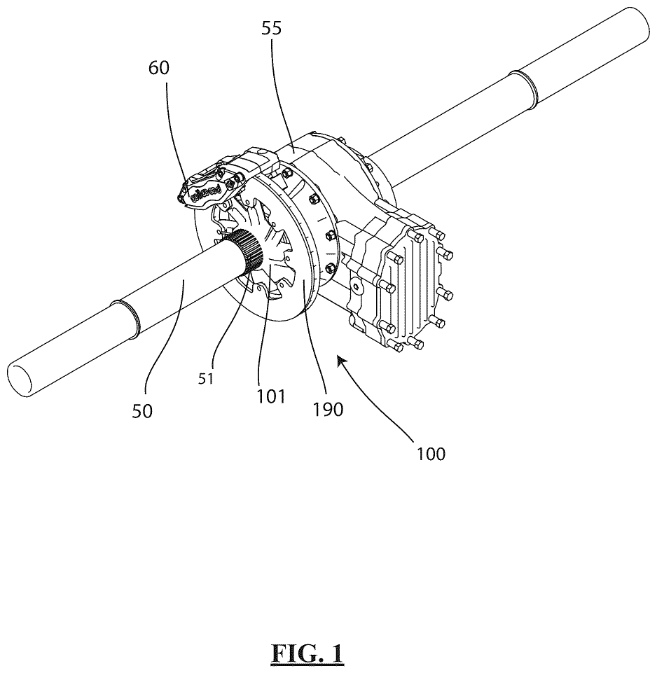

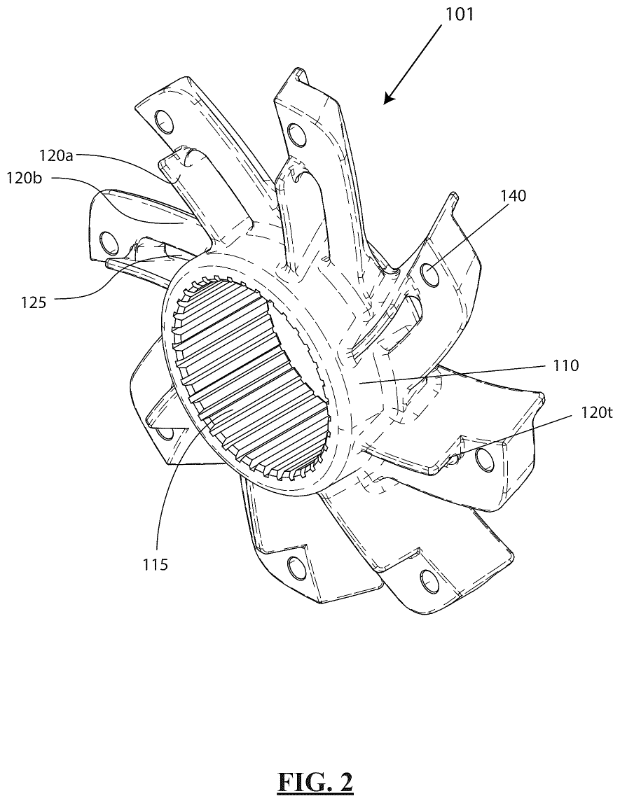

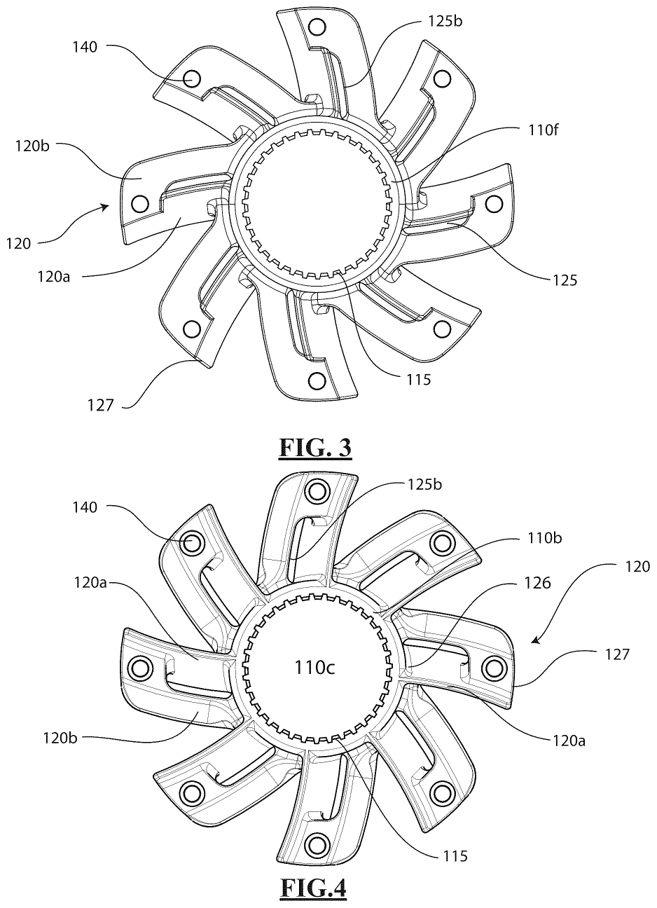

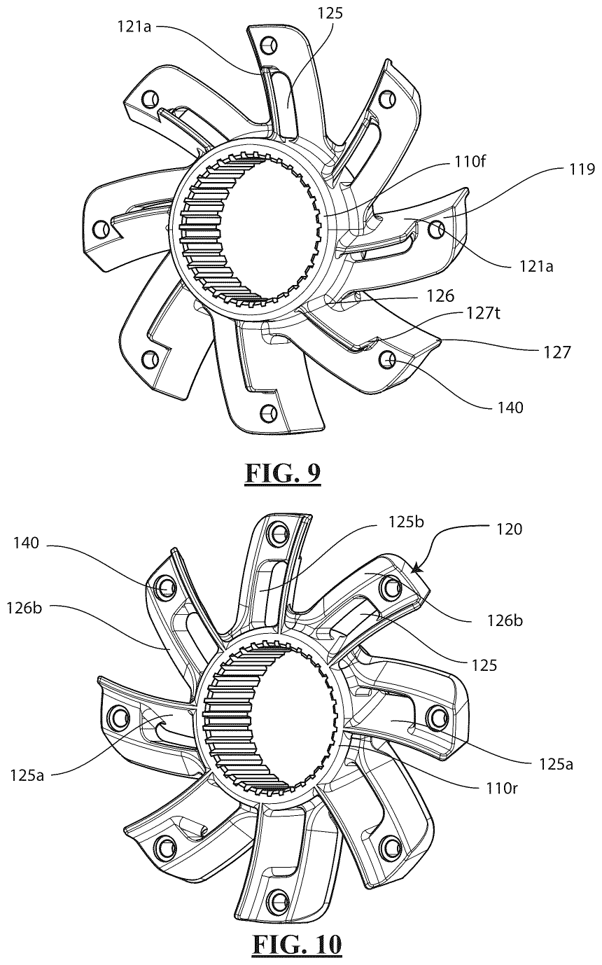

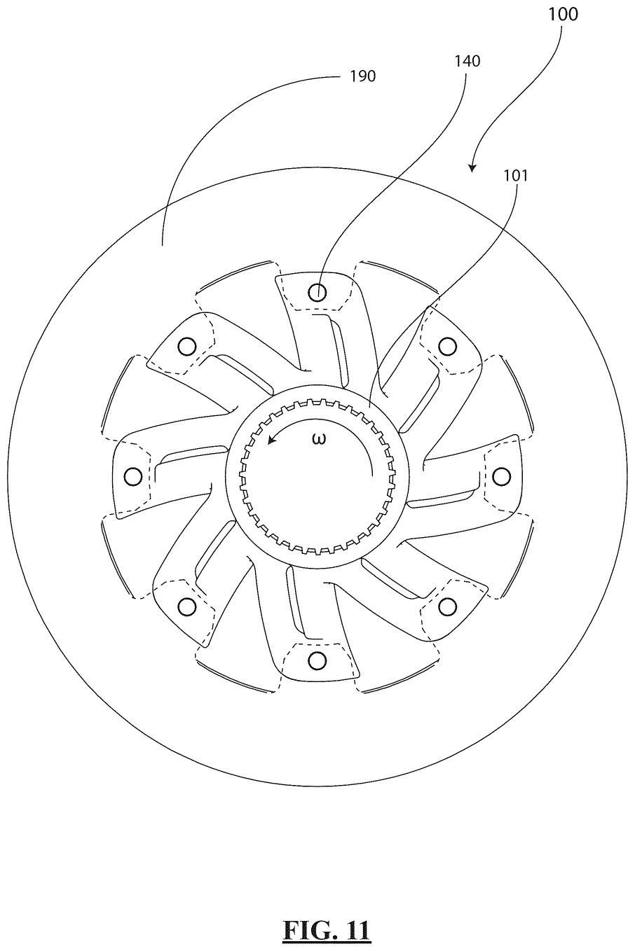

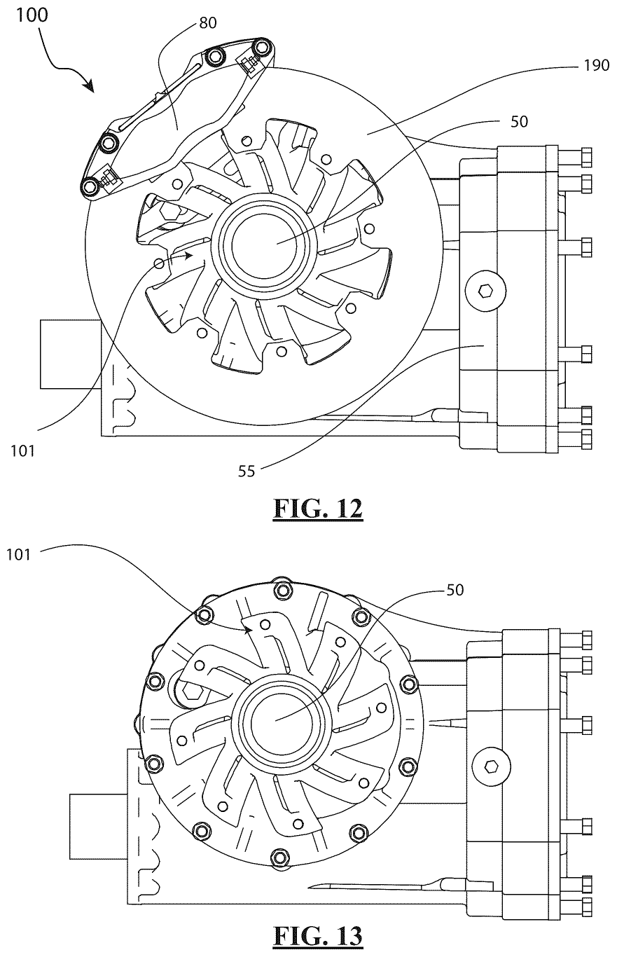

Referring to the drawings, wherein like reference characters designate like or corresponding parts throughout the several views, and referring particularly to FIGS. 1-13, it is seen that the present invention includes various embodiments of a rotor hub having a plurality of vanes operable to generate a wake or vortex for cooling a brake disc within an axle assembly.

The present invention concerns an inboard floating rotor assembly 100 having a floating hub adapter 101 that is operable to secure a brake disc 190 (e.g., brake rotor) to an axle shaft 50. The floating hub adapter 101 may include a central hub 110 having a central bore 110c having a plurality of splines 115 for aligning and fastening to the axel shaft 50. The hub adapter 101 further includes a plurality of vanes (120) radially extending from the exterior of the hub 110, the vanes 120 may include a fluid channel 125 separating a primary vane 120a (e.g., blade), and a secondary vane 120b (e.g., reinforcing member), each of vane may include a through-hole 140 that is operable to align a brake disk 190 and secure the rotor to the axel hub adapter 101 using a plurality of fasteners (not shown). The plurality of vanes 120 together may form an impeller that is operable to generate a radial airflow drawing air from the center of the rotor and expelling outward, creating a centrifugal airflow pattern that is operable to effectively cool the brake disc 190, and brake caliper 80, by continuously directing air away from the disc. The brake disc 190 may be vented or solid and may include a plurality of slots, holes, or other patterns to enhance cooling and reduce weight.

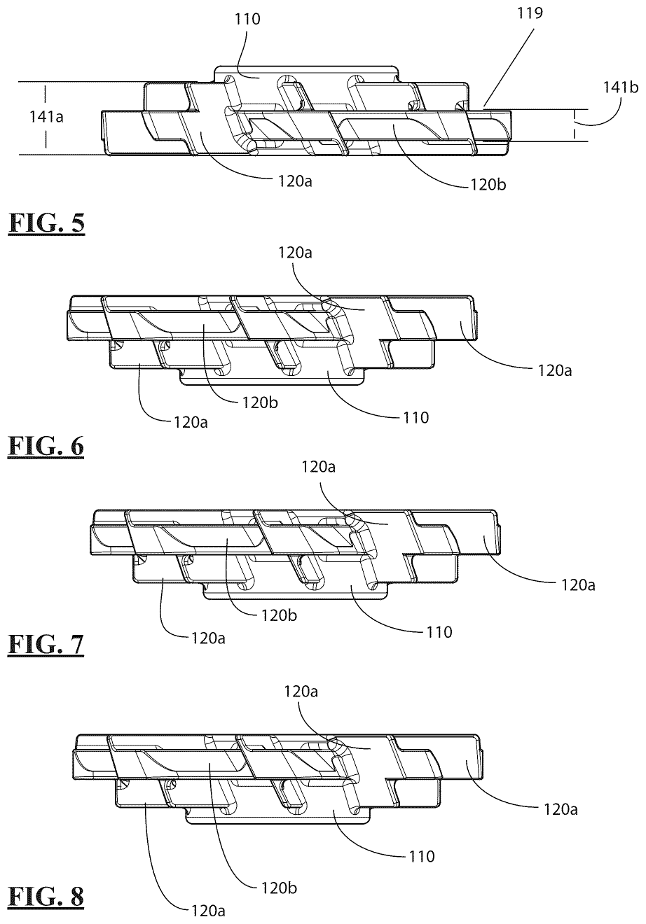

Throughout the drawings, it is shown that a forward-curved blade geometry is used. However, a person with ordinary skill in the art may use a flat blade or backward-curved blade geometry to change the direction of the air leaving the blade tips. As shown in FIG. 5, the primary vane 120a may have a constantly curved surface with a span 141a that is substantially equivalent to the length of the hub 110, thereby having a larger surface area in contact with the air. The primary vane 120a may have a constant blade thickness along its length, with the exception of the connection of the secondary vane 120b at the periphery of the primary vane 120a. In some embodiments, the primary and secondary vanes may be connected with a plurality of bridges and ridges or with a plurality of curved connecting members.

The secondary vane 120b may have a radial path that is substantially equivalent to the radial path of the primary vane 120a and may have a substantially flat top surface 119 that is perpendicular to the central axis of the hub 110, which provides a flat surface to uniformly secure the brake disc to the rotor 100. As shown in FIG. 5, the secondary vane 120b has a span 141b that is operable to provide a reinforcing structure to secure the brake disc 190 to the hub adapter 101 while providing limited interference with the blade geometry of the primary vane 120a.

In some embodiments, the brake disc 190 may be secured to the periphery of the vanes 120 using a standardized bolt pattern, ensuring compatibility and structural integrity within the braking system. The bolt pattern may include a plurality of equidistantly spaced through-holes 140 arranged in a circular configuration around the periphery of the rotor hub 101, facilitating uniform distribution of braking forces across the hub assembly. The bolt circle diameter (BCD) of the pattern may vary based on application requirements, with common configurations including 4, 5, 6, or 8 bolts for compact to high-performance systems. In some embodiments, the bolt pattern may include contact surfaces or indexing features, such as alignment pins or slots, to ensure proper orientation of the brake disc 190, particularly for vented or slotted designs, thereby optimizing airflow and enhancing cooling performance. This configuration minimizes vibration, ensures consistent load distribution, and prevents premature wear of the rotor hub assembly during operation.

The primary vane 120a, secondary vane 120b, and fluid channel 125 may share various facets and have various surfaces, and for clarity, it is to be appreciated that the reference characters herein are related to the surfaces of the hub adapter 101. As shown in FIGS. 3-4, 9, and 10, the primary vane 120a may have a leading surface 121a, a primary peripheral edge 127 (e.g., outlet), and a root 126 (e.g., inlet), and a secondary peripheral edge 127t. The secondary vane 120b may include an interior surface 126b that may be tapered, flat, or curved to minimally interfere with the airflow generated from the front surface 121a of the primary vane. The fluid channel 125 may share surfaces with the front surface of the secondary vane 120b and the interior surface of the primary vane 120a. The fluid channel 125 may have a first surface 125a that is complementary to the curvature of the front surface 121a and may have a second surface 125b that is substantially parallel to the central axis of the hub 110 and perpendicular to the front surface 110f of the hub 110 along the radial path of the secondary vane 120b.

In some embodiments, the secondary vane 120b may be characterized as a reinforcing member coupled to the tip of the primary vane 120a and the hub 110, thereby increasing the structural rigidity and thermal capacity of the assembly. By providing a substantially larger surface area in direct thermal communication with the brake disc 190, the secondary vane 120b may enhance heat dissipation and improve overall system durability. During high-temperature braking conditions, the increased surface area of the reinforcing member is operable to absorb and distribute heat more effectively, mitigating localized thermal stress and prolonging the service life of the rotor hub assembly. In operation, the vanes 120 may generate a low-pressure zone at the inlet 126 (e.g., the interface of the vane and hub) and a high-pressure zone at the outlet 127 (e.g., the periphery of the vane), thereby creating a pressure gradient that is operable to ensure consistent airflow through the rotor and ensuring a uniform cooling across the exterior and interior surfaces of the brake disc 190. he resulting airflow effectively removes heat generated by friction between the brake disc and caliper, stabilizing operating temperatures and preventing performance degradation due to brake fade.

In some embodiments, the vanes 120 may be constructed from a thermally conductive material that is operable to transfer heat away from the brake assembly via convection. Suitable materials may include aluminum alloys (e.g., 6061 or 7075 series) known for their high thermal conductivity and favorable strength-to-weight ratio, copper-based alloys that offer excellent heat dissipation characteristics, or magnesium alloys that balance lightweight construction with efficient heat transfer. Additionally, advanced composite materials or metal-matrix composites integrating high-conductivity fibers or particles may be employed to further optimize the thermal management properties of the vane structure. In operation the fluid channel 125 may be operable to align the air movement with the radial direction of the rotor vanes 120 as the rotor 101 spins, the air flowing through the fluid channel interacts with the rotating vanes 120 and the sharp edges of the fluid channel cause small vortices near the outlet thereby mixing the air the cyclic exposure of each fluid channel to incoming air creates a pulsating flow pattern, thereby enhancing the dynamic cooling effect and ensures that fresh air is constantly drawn into and through the fluid channel, to break up stagnant hot air.

It is to be understood that variations, modifications, and permutations of embodiments of the present invention, and uses thereof, may be made without departing from the scope of the invention. It is also to be understood that the present invention is not limited by the specific embodiments, descriptions, or illustrations or combinations of either components or steps disclosed herein. The embodiments were chosen and described in order to best explain the principles of the invention and its practical application, to thereby enable others skilled in the art to best utilize the invention and various embodiments with various modifications as are suited to the particular use contemplated. Although reference has been made to the accompanying figures, it is to be appreciated that these figures are exemplary and are not meant to limit the scope of the invention. It is intended that the scope of the invention be defined by the claims appended hereto and their equivalents.

What is claimed is:

1. A rotor hub adapter for an inboard braking system, the adapter comprising:
a. a hub operable to secure to an axle shaft;
b. a plurality of vanes radially distributed around a circumference of said hub, each vane comprising:
i. a blade body extending radially outward from a root portion connected to said hub, a leading edge, a trailing edge, and a blade surface between, the blade surface having a primary peripheral edge and a secondary peripheral edge,
ii. a reinforcing member connected to said root portion and said primary peripheral edge, the reinforcing member having a through-hole positioned between said primary and secondary peripheral edge, and
iii. a fluid channel positioned between said blade and reinforcing member; and
c. a brake disc fastened to each through-hole of each vane in said plurality of vanes.
wherein said plurality of vanes are operable to generate a radial airflow creating a pressure gradient, the airflow being directed towards the brake disc for cooling.

2. The adapter of claim 1, wherein said blade has a forward-curved blade geometry that is operable to direct a magnitude of an airflow vector toward said brake disc.

3. The adapter of claim 1, wherein said fluid channel is operable to reduce turbulence and generate a pulsating flow during rotation to enhance air mix and mitigate heat stagnation around the brake disc.

4. The adapter of claim 1, wherein said reinforcing member includes a flat surface on said primary peripheral edge that is operable to provide a uniform interface with the brake disc

5. The adapter of claim 4, wherein said through-hole is positioned through said flat surface and is operable to align apertures on said brake disc.

6. The adapter of claim 1, further comprising indexing features at said through-holes, the indexing features being operable to ensure proper alignment of the brake disc relative to the hub.

7. The adapter of claim 1, wherein said blade forms an air pressure gradient having a low pressure zone at the root of the blade and hub to draw in air, and a high pressure zone near the periphery to expel air at an increased velocity

8. The adapter of claim 1, wherein said hub is operable to secure to a shaft using a plurality of splines on an interior surface of the hub that align with splines on the axle shaft.

9. A floating brake disc, comprising:
a. a hub defining a central axis and having a bore configured to mount the hub to an axle;
b. a plurality of spokes radially extending from the central hub to a periphery, each spoke having a fan blade shape operable to generate an airflow during rotation, the fan blade shape comprising:
i. a leading edge configured to guide airflow along the spoke,
ii. a trailing edge configured to discharge airflow radially outward;
c. a plurality of contact surfaces at or near the periphery of the spokes, the contact surface being operable to align with corresponding apertures in a brake disc and to secure the brake disc to the rotor hub;
wherein the spokes are operable to generate a centrifugal airflow pattern during rotation, the airflow being directed over and away from the brake disc to enhance heat dissipation and cooling of the brake assembly.

10. The rotor hub of claim 9, further comprising a reinforcing member positioned adjacent to each of said spokes, wherein said reinforcing member is operable to absorb a braking load from the brake disc to the hub and structurally support the rigidity of the spoke under the centrifugal force during rotation.

11. The rotor hub of claim 10, further comprising a fluid channel positioned between each spoke and the corresponding reinforcing member, wherein said fluid channel is operable to reduce turbulence and generate a pulsating flow during rotation to enhance air mix and mitigate heat stagnation around the brake disc.

12. The rotor hub of claim 9, wherein said contact surfaces are strategically positioned along the periphery of each spoke to distribute the load of the brake disc evenly across the rotor hub.

13. The rotor hub of claim 12, wherein said reinforcing member includes a flat surface at the peripheral edge that is operable to provide a uniform interface with the brake disc.

14. The rotor hub of claim 13, wherein said blade forms an air pressure gradient having a low pressure zone at the root of the blade and hub to draw in air, and a high pressure zone near the periphery to expel air at an increased velocity.

15. The rotor hub of claim 14, wherein said plurality of spokes and corresponding reinforcing members are integrally formed as a single structure.

16. The rotor hub of claim 14, wherein said bore includes a plurality of splines that are configured to align with splines on the axle.

17. A method of cooling a braking assembly in a vehicle, the method comprising:
a. securing rotor hub adapter to an axle shaft, the adapter comprising:
i. a hub defining a central axis and having a plurality of vanes radially distributed around the hub, and
ii. a brake disc fastened to through-holes at a peripheral edge of each vane; and
b. b. rotating the rotor hub adapter about the central axis, wherein each vane generates a radial airflow by creating a pressure gradient, the airflow being directed over the brake disc to dissipate heat generated during braking and away from the braking assembly to prevent heat stagnation.

18. The method of claim 17, further comprising directing airflow through a fluid channel positioned between each vane and a corresponding reinforcing member, the fluid channel being operable to generate vortices at an outlet to enhance air mixing and prevent localized heat buildup around the brake disc.

19. The method of claim 17, wherein said brake disc comprises a plurality of slots or apertures that are operable to guide the airflow generated by the vanes through the slots or apertures of the brake disc to enhance the cooling effect by increasing the surface area exposed to the airflow.

20. The method of claim 17, further comprising maintaining balanced rotational dynamics of the rotor hub adapter by spacing the vanes equidistantly around the hub to minimize vibrations and noise during rotation and improve operational stability of the braking assembly.
